(19) United States
(12) Patent Application Publication
(10) Pub. No.: US 2010/0164936 A1
(43) Pub. Date: Jul. 1, 2010

(54) DIFFERENTIAL SIGNALLING SERIAL INTERFACE CIRCUIT

(76) Inventors: Wook Hee Park, Gangnam-gu (KR); Young Bin Yoon, Songpa-gu (KR)

Correspondence Address: SHERR & VAUGHN, PLLC, 620 HERNDON PARKWAY, SUITE 320, HERNDON, VA, 20170, US

(21) Appl. No.: 12/649,157

(22) Filed: Dec. 29, 2009

(30) Foreign Application Priority Data
Dec. 30, 2008 (KR) 10-2008-0137605

(51) Int. Cl. G06F 3/038

(52) U.S. Cl. 345/211

(57) ABSTRACT

A differential signaling serial interface circuit includes a receiver including a voltage comparator having input terminals with a termination resistor R_{T}, a panel in front of the receiver, the panel having a load, and a transmitter for supplying a differential input current to the load of the panel.

This application claims the benefit of the Patent Korean Application No. 10-2008-0137605, filed on Dec. 30, 2008, which is hereby incorporated by reference as if fully set forth herein.

### BACKGROUND

FIG. 1 illustrates a related push-pull type differential signaling serial interface circuit. Referring to FIG. 1, in a case of a general TFT-LCD, an output driving current I_{D} from a timing controller (TCON) transmitter is turned into a voltage (I_{D}*R_{T}=V_{DIFF}) at a PCB where a timing controller is positioned.

The voltage V_{DIFF} is applied to a voltage comparator of a COF (Chip On Film) packaged column driver receiver. Then, the column driver receiver detects a difference of the voltage V_{DIFF} and restores a signal. In this instance, a transmission path of the voltage _{VDIFF} exists only at the PCB and the COF, and has relatively low resistance in view of nature of the path. For an example, the resistance of a signal line pattern of the PCB may not exceed 10 ohm at the maximum. Accordingly, owing to the small attenuation of the voltage V_{DIFF}, the voltage comparator of the column driver receiver can make stable signal restoration.

However, in a case of a TFT-LCD COG (Chip On Glass) panel, the column driver receiver is bonded to the panel directly. Therefore, a signal pattern of the panel is added to the path of an existing voltage V_{DIFF}, making the signal pattern of the panel have a resistance R_{P} of about 100˜300 ohm. Consequently, the voltage V_{DIFF} being applied to the voltage comparator of the column driver receiver with a voltage drop of I_{D}*R_{T} fails to maintain an original value, but may be attenuated in proportion to the resistance added to the signal line pattern, with a subsequent failure of the stable restoration of the signal, which can minimize the reliability of entire circuit.

### SUMMARY

Embodiments relate to semiconductor circuits, and, more particularly, to a push-pull type differential signaling serial interface circuit. Embodiments relate to a differential signaling serial interface circuit having a termination resistance R_{T} embedded therein.

Embodiments relate to a differential signaling serial interface circuit which enables a fast signal transmission at a TFT-LCD COF panel which has a heavy signal routing resistance characteristic. Embodiments relate to a differential signaling serial interface circuit for maximizing circuit yield and reliability.

Embodiments relate to a differential signaling serial interface circuit that includes a receiver including a voltage comparator having input terminals with a termination resistor R_{T}, a panel in front of the receiver, the panel having a load, and a transmitter for supplying a differential input current to the load of the panel. The circuit may be a push-pull type. Also, the termination resistor R_{T} may be connected with the two input terminals of the voltage comparator.

The panel may be a COG (Chip On Glass) panel, and the panel may include resistors Rmp and Rmn respectively connected to the two input terminals of the voltage comparator in series as loads, and capacitors Cmp and Cmn respectively connected to the two input terminals in parallel and respectively connected to ground terminals VSS.

### DRAWINGS

FIG. 1 illustrates a related push-pull type differential signaling serial interface circuit.

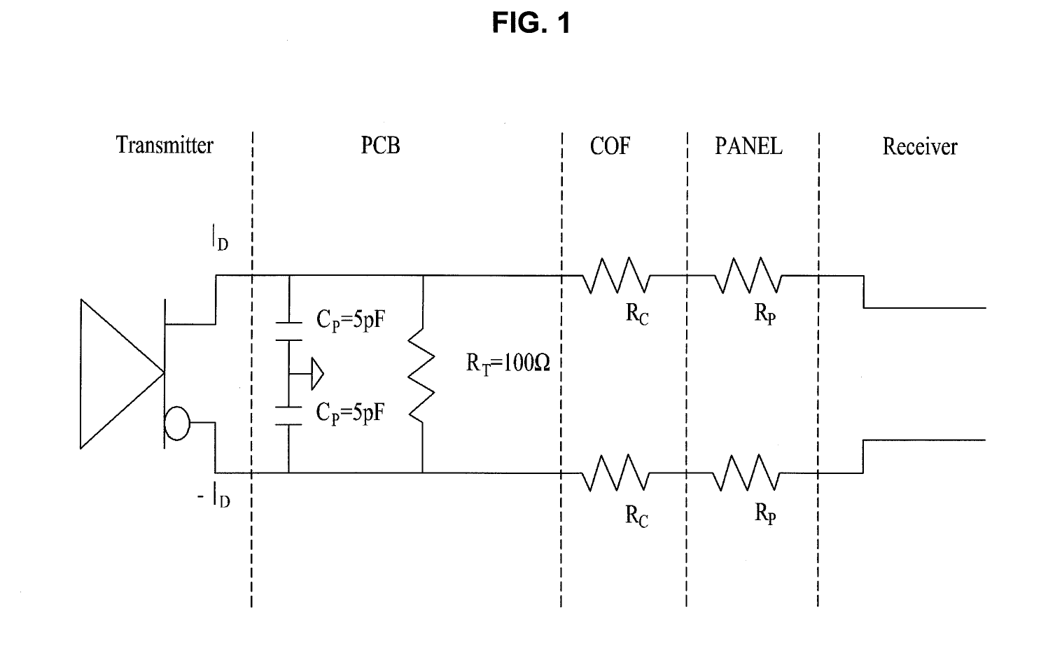

FIG. 2 illustrates a push-pull type differential signaling serial interface circuit in accordance with embodiments.

### DESCRIPTION

Reference will now be made in detail to embodiments, examples of which are illustrated in the accompanying drawings. Wherever possible, the same reference numbers will be used throughout the drawings to refer to the same or like parts.

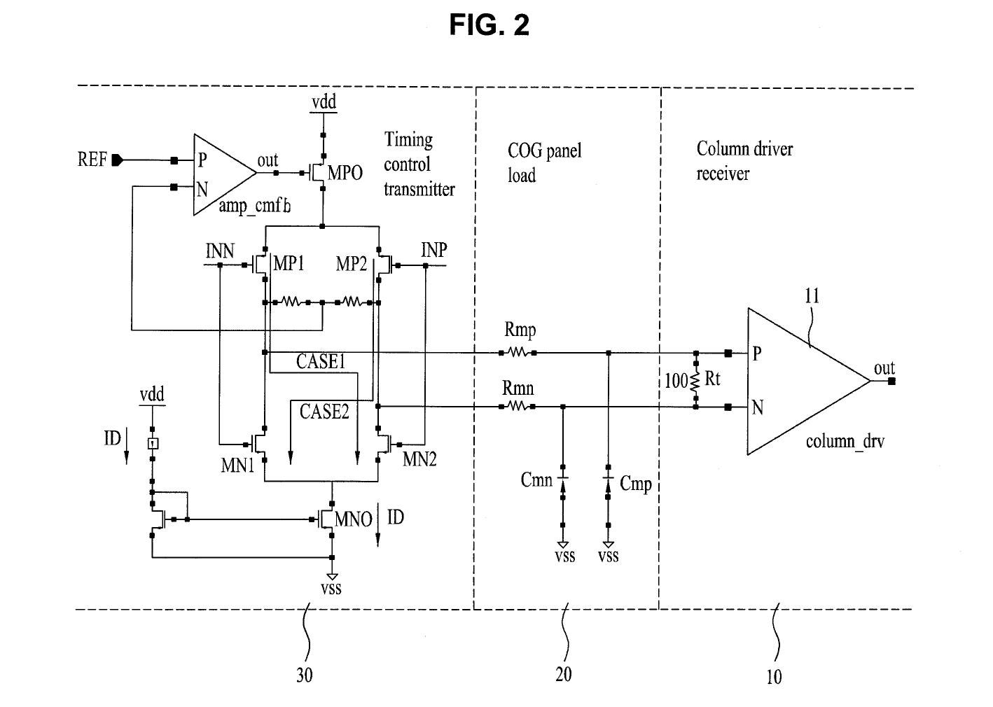

FIG. 2 illustrates a push-pull type differential signaling serial interface circuit in accordance with embodiments. Referring to FIG. 2, a circuit includes a column driver receiver 10 provided with a voltage comparator 11, and a termination resistor R_{T} provided to two input terminals P and N thereof. The circuit has the termination resistor R_{T} embedded in the column driver receiver 10. Particularly, the termination resistor R_{T} can connect the two input terminals P and N.

A COG panel 20 provided to an input terminal of the voltage comparator 11 may include resistors Rmp and Rmn connected to input terminals of the voltage comparator 11 in series respectively, and capacitors Cmp and Cmn connected to the input terminals of the voltage comparator 11 in parallel and connected to ground terminals VSS respectively, as loads thereof. In front of the COG panel 20, there may be a timing control transmitter 30 for supplying INP and INN which are differential input currents.

By embedding the termination resistor R_{T}, not in a PCB, but in the column driver receiver 10, in accordance with embodiments, attenuation of a signal due to resistance caused by mounting of the COG panel 20 can be minimized.

Transistors MP1 and MN2, or MP2 and MN1 may be repeatedly turned on/off by the NP and INN which are differential input currents. In detail, transistors MP1 and MN1 each having a gate to which a differential input current INN is applied thereto are turned on/off repeatedly, and transistors MP2 and MN2 each having a gate to which a differential input current NP is applied thereto are turned on/off repeatedly. The MP1 and MP2 are PMOS transistors, and the MN1 and MN2 are NMOS transistors.

According to turning on/off of the transistors, a current path may be formed through the resistors Rmp and Rmn of the COG panel 20. That is, as an example, since the INN is low if the NP is high (CASE 1), the MP1 and MN2 are turned on, to form the current path through the MP1 and Rmp, the MN2 and Rmn, and the R_{T}. As another example, since the INP is low if the INN is high (CASE 2), the MP2 and MN1 are turned on, to form the current path through the MP2 and Rmp, the MN1 and Rmn, and the R_{T}.

A current I_{D}, formed in the above examples, may be turned to a differential voltage V_{DIFF} by the resistors Rmp, Rmn, R_{T}. The differential voltage V_{DIFF} can be applied to the voltage comparator 11 of the column driver receiver 10.

In accordance with embodiments, since not a voltage, but a current I_{D}, passes through the Rmp, Rmn, Cmp, Cmn which are loads of the COG panel 20, an output voltage can be applied to the voltage comparator 11 of the column driver receiver 10 without attenuation, thereby enabling regular restoration of the signal.

As has been described, the differential signaling serial interface circuit of embodiments has a number of advantages. The embedding of the termination resistor R_{T} in a receiver permits no attenuation of an output, enabling stable restoration of a signal, to maximize circuit yield and reliability, significantly.

The embedding of the termination resistor R_{T} in a receiver also permits a relatively fast signal transmission at a TFT-LCD COG panel having a heavy signal routing characteristic.

It will be obvious and apparent to those skilled in the art that various modifications and variations can be made in the embodiments disclosed. Thus, it is intended that the disclosed embodiments cover the obvious and apparent modifications and variations, provided that they are within the scope of the appended claims and their equivalents.

What is claimed is:

1. A device comprising:
a receiver including a voltage comparator having input terminals with a termination resistor;
a panel in front of the receiver, the panel having a load; and
a transmitter for supplying a differential input current to the load of the panel.

2. The device of claim 1, wherein the device is a differential signaling serial interface circuit.

3. The device of claim 2, wherein the device is a push-pull type.

4. The device of claim 1, wherein the termination resistor is electrically coupled to the input terminals of the voltage comparator.

5. The device of claim 1, wherein the panel is a Chip On Glass panel.

6. The device of claim 1, wherein the panel includes a first panel resistor and a second panel resistor respectively electrically coupled to the input terminals of the voltage comparator in series as loads.

7. The device of claim 1, wherein the panel includes a first panel capacitor and a second panel capacitor respectively electrically coupled to the input terminals in parallel and respectively electrically coupled to ground terminals.

8. The device of claim 1, wherein the receiver is a column driver receiver.

9. The device of claim 1, wherein the transmitter is a timing control transmitter.

10. The device of claim 1, wherein the differential input current supplied to the transmitter is turned to a differential voltage by the panel load and the termination resistor.

11. The device of claim 10, wherein the differential voltage is applied to the voltage comparator.

12. The device of claim 1, wherein the termination resistor is embedded in the receiver, and the termination resistor electrically couples the input terminals of the receiver.

13. The device of claim 2, wherein the termination resistor is electrically coupled to the input terminals of the voltage comparator.

14. The device of claim 2, wherein the panel is a Chip On Glass panel.

15. The device of claim 2, wherein the panel includes a first panel resistor and a second panel resistor respectively electrically coupled to the input terminals of the voltage comparator in series as loads.

16. The device of claim 2, wherein the panel includes a first panel capacitor and a second panel capacitor respectively electrically coupled to the input terminals in parallel and respectively electrically coupled to ground terminals.

17. The device of claim 2, wherein the receiver is a column driver receiver.

18. The device of claim 2, wherein the transmitter is a timing control transmitter.

19. The device of claim 2, wherein the differential input current supplied to the transmitter is turned to a differential voltage by the panel load and the termination resistor and the differential voltage is applied to the voltage comparator.

20. The device of claim 2, wherein the termination resistor is embedded in the receiver, and the termination resistor electrically couples the input terminals of the receiver.
